(19) United States
(12) Patent Application Publication
(10) Pub. No.: US 2024/0008112 A1
(43) Pub. Date: Jan. 4, 2024

(54) WEARABLE ELECTRONIC DEVICE WITH SWITCH-ENABLED COMMUNICATIONS

(71) Applicant: Shoshi Liliya Kaganovsky, Houston, TX (US)

(72) Inventor: Shoshi Liliya Kaganovsky, Houston, TX (US)

(21) Appl. No.: 18/253,579

(22) PCT Filed: Nov. 9, 2021
(86) PCT No.: PCT/IB2021/060376

§ 371 Date: May 18, 2023

Related U.S. Application Data
(60) Provisional application No. 63/116,080, filed on Nov. 19, 2020.

(51) Int. Cl. H04W 76/14

(52) U.S. Cl. CPC H04W 76/14; G08B 25/10

(57) ABSTRACT

A wearable electronic device with switch-enabled communications is disclosed. The switch-enabled communication may be enabled with an enhanced ring that includes at least a switch and a short range communication circuit and a paired device, to which the enhanced ring is paired and maintained in close proximity thereto. A user may activate the switch on the enhanced ring to trigger a short range signal to the paired device. The paired device receives and interprets the short range signal and, in response, initiates one or more predetermined transmissions to designated individuals or institutions via a long range transmission. The paired device may include both short range and long range radios in order to facilitate both the switch-enabled communications with the enhanced ring and the long range transmissions of the predetermined transmissions to the designated individuals.

### CROSS-REFERENCE TO RELATED APPLICATIONS

This application claims the benefit of U.S. Provisional Patent Application No. 63/116,080, entitled, “WEARABLE ELECTRONIC DEVICE WITH SWITCH-ENABLED COMMUNICATIONS,” filed on Nov. 19, 2020, which is expressly incorporated by reference herein in its entirety.

### BACKGROUND

### Field

Aspects of the present disclosure relate generally to wearable electronic devices, and more particularly, to a wearable electronic device with switch-enabled communications.

### Background

Wireless communications have seen a revolution of reliability and accessibility since the introduction of the first mobile, cellular phones. Advances in semiconductor fabrication has lead to greater miniaturization of microprocessors, transceivers, and memory, which have resulted in more powerful and smaller communications devices. Advanced radio access technologies (RATs), such as the 3^{rd} Generation Partnership Project (3GPP) long term evolution (LTE), LTE-Advanced, and the 5^{th} generation (5G) new radio (NR) technologies have increased the reach of reliable wireless communication technology beyond user mobile phones into other types of user devices, controls, and equipment, in addition to various household and commercial appliances. These devices that are wirelessly connected to the internet via such advanced RATs, such as LTE and 5G NR are known as internet-of-things (IoT) devices.

Another advancement in wireless technologies includes wearable devices that may have wireless communication technology embedded within the device, whether enabling wireless connections via a short range wireless RAT, such as WiFi™, Bluetooth™, Bluetooth™ Low Energy (LE), Zigbee™, radio frequency identification (RFID) transponders, near-field communication (NFC) technologies, and the like, or long range wireless RAT, such as 3G, LTE, 5G NR, and the like, or both. For example, smart watches exist that may establish voice or data communications with a paired user mobile phone via a short range RAT and conduct communications through capabilities of the paired user mobile phone, while other smart watches additionally or alternatively include independent long range wireless capabilities that may implement long range voice or data communications independently of any paired user mobile phone. As semiconductor fabrication technologies continue to advance, the form factor for such wearable devices enabled with short range and/or long range wireless communication capabilities may be reduced in a manner that provides capabilities for smaller connected wearable devices, such as rings, bracelets, earrings, and the like.

### SUMMARY

In one aspect of the disclosure, a method of switch-enabled communication by a virtual communication device including an enhanced ring, with a physical switch interface, and a paired device, wirelessly paired to the enhanced ring, wherein the enhanced ring and the paired device are, at least initially, maintained on a body of a user, the method including detecting a physical switch input from the user at the physical switch interface, wherein the physical switch input is indicative of activation of the switch-enabled communication, exchanging, via a short-range radio access technology (RAT), an activation signal between the enhanced ring and the paired device of the virtual communication device, wherein the activation signal indicates activation of the switch-enabled communication, and transmitting, via a long-range RAT, a predetermined transmission from the paired device to one or more designated recipients in response to the activation signal.

In an additional aspect of the disclosure, a paired device configured for switch-enabled communication includes one or more processors, a long-range communication radio coupled to the one or more processors, a short-range communication radio coupled to the one or more processors, a memory coupled to the one or more processors including logic stored thereon to configure switch-enabled communication, wherein the logic, when executed by the one or more processors, configures the paired device: to establish wireless pairing with an enhanced ring via the short-range communication radio; to monitor for an activation signal from the enhanced ring via the short-range communication radio; and to transmit a predetermined transmission via the long-range communication radio to one or more designated recipients in response to the activation signal, and a form factor encapsulating the one or more processors, the long-range communication radio, the short-range communication radio, and the memory.

In an additional aspect of the disclosure, an enhanced ring configured for switch-enabled communication includes one or more processors, a short-range communication radio coupled to the one or more processors, a physical switch interface accessible by a user, a memory coupled to the one or more processors including logic stored thereon to configure switch-enabled communication, wherein the logic, when executed by the one or more processors, configures the paired device: to establish wireless pairing with a paired device via the short-range communication radio, to detect physical switch input of the physical switch interface, wherein the physical switch input is indicative of activation of the switch-enabled communication, to transmit an activation signal associated with the physical switch input via the short-range communication radio to the paired device in response to the physical switch input, and a ring housing encapsulating the one or more processors, the short-range communication radio, and the memory, wherein the physical switch interface is accessible by the user through the ring housing.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a communication system having an enhanced ring and a paired device, each configured to provide switch-enabled communication according to one aspect of the present disclosure, on the person of user is a block diagram illustrating.

FIGS. 2A-2B are block diagrams illustrating an enhanced ring configured to provide switch-enabled communications according to one aspect of the present disclosure.

FIGS. 3A-3B are block diagrams illustrating an enhanced ring configured to conduct switch-enabled communications according to aspects of the present disclosure.

FIG. 4 is a block diagram illustrating a user in possession of and wearing an enhanced ring and paired device configured for a switch-enabled communications system according to one aspect of the present disclosure.

FIG. 5 is a block diagram illustrating a user in possession of and wearing an enhanced ring and paired device configured for a switch-enabled communications system according to one aspect of the present disclosure.

FIG. 6 is a block diagram illustrating a user in possession of and wearing an enhanced ring and paired device configured for a switch-enabled communications system according to one aspect of the present disclosure.

FIG. 7 is a block diagram illustrating an example implementation of a paired device configured to provide switch-enabled communications according to one aspect of the present disclosure.

FIG. 8 is a block diagram illustrating an example implementation of an enhanced ring configured to provide switch-enabled communications according to one aspect of the present disclosure.

FIG. 9 is a block diagram illustrating example blocks executed by a virtual communication device including an enhanced ring and a paired device and configured to provide switch-enabled communications according to aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

As the wireless communication industry has evolved, the commonly-accepted paradigm for personal communications over that evolution has been a voice call or text message using the user interfaces of a personal mobile phone or a wireless-enabled wearable device. While this typical communication paradigm is generally recognized as a communications methodology, there may be certain circumstances where this commonly-known communication method either may not be available or advisable. For example, a user's mobile phone or wearable device battery may be completely discharged. In another example, a person may have fallen and cannot reach their mobile phone or wearable device. In still another example, a person may be in an externally-restrained state, such as during an attempted abduction where the persons limbs may be bound, or if the restraint is due to being threatened with a weapon. In such externally-restrained situations, the assailant would recognize the commonly-known communication methods and would not allow the person/victim to perform those types of communications. Accordingly, development of more discretely-controlled communication methodologies may benefit individuals in such circumstances where the commonly-known communication methods are either not available or not advisable.

There have been developments for discretely-controlled communication methods in the area of emergency or panic situations. Wearable emergency devices are available which provide for some type of discretely-controlled communications, such as a panic button embedded in a ring, bracelet, pendant, and other wearable-type devices. Limitations have been realized in current such wearable emergency devices. For example, some devices include a “panic” button that the user depresses to activate the emergency signal. An important performance feature of wearable emergency devices is reliability. Panic buttons often suffer from false activation. Because a depression of the panic button activates the emergency signal, regular human activity may cause an accidental activation of the button.

Additional devices include wearable emergency rings that include all of the microelectronics to implement an activation circuit and a long range communication circuit, including antennas, and the battery technology to operate all of the wireless communication electronics. Such all-in-one rings have an obviously large form factor. An assailant that would observe such a large ring on the finger of a potential victim may recognized some kind of communication device and remove the ring, thus, defeating the purpose of the wearable emergency device.

Additional devices include microphones that listen for certain key words or phrases that indicate the wearer of the device is in an emergency situation. Other devices monitor a location of the wearer and, if the wearer leaves the boundaries of a predefined location, an emergency signal is activated. Each of these example emergency-type discretely-controlled communication devices rely on additional processing to determine if the wearer/user is, in fact, in an emergency situation. The various aspects of the present disclosure are directed to a switch-enabled communication paradigm that allows the user to discretely control when to activate the communication signal and that lowers the probability of false activation.

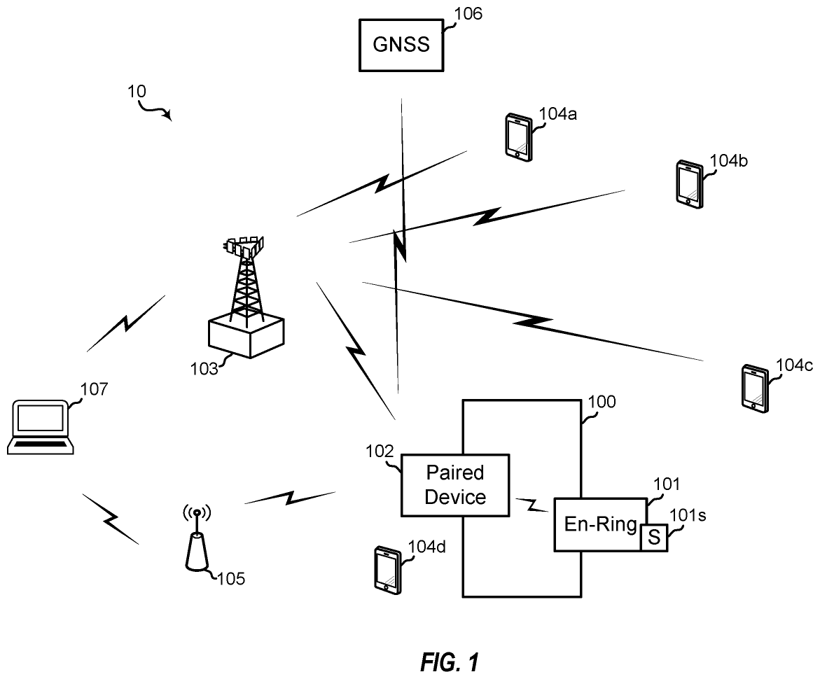

FIG. 1 is a block diagram illustrating a communication system 10 having an enhanced ring 101 and a paired device 102, each configured to provide switch-enabled communication according to one aspect of the present disclosure, on the person of user 100. A switched communication system according to the illustrated aspect includes enhanced ring 101 being worn by user 100. Enhanced ring 101 is a wearable electronic device configured to include a short range communication circuit (not shown) and a switch 101s operable to provide input to the communication circuit through movement of the switch by user 100.

Enhanced ring 101 is wirelessly paired to paired device 102. Paired device 102 is another wearable electronic device that may be implemented as a bracelet, a watch, a necklace, a pendant, and the like. Enhanced ring 101 may be paired to paired device 102 via a short range wireless RAT, such as WiFi™, Bluetooth™, Bluetooth™ Low Energy (LE), Zigbee™ RFID scanner/reader, NFC, and the like. Paired device 102 includes both a short range communication circuit (not shown) and a long range communication circuit (not shown). Paired device 102 may wirelessly connect to a cellular-style communication network via base station 103. The cellular-style communication network may be implemented using a RAT such as 3G, LTE, 5G NR, and the like. Limiting the communications capability of enhanced ring 101 allows it to take a smaller, more typical form factor of non-electronic rings. Such a smaller form factor may be less noticeable as a communication device. Additionally, with fewer electronics, a smaller battery (or no battery when relying on a passive RFID communication system) may be used which results in a lower component cost and the potential to have even a disposable implementation.

The combination of enhanced ring 101 paired with paired device 102 may implement two parts of a virtual communication device 108 maintained on the person of a user. The user may then implement the various aspects providing switch-enabled communication using each part of virtual communication device 108.

As user 100 may desire to initiate switched communication, user 100 moves switch 101s on enhanced ring 101 to a predetermined position. Switch 101s may be implemented as a toggle-type switch, which allows user 100 to switch between two predetermined positions, or a multi-positional switch, which allows user 100 to switch between multiple predetermined positions. User 100 moves switch 101s to a predetermined position that provides communication input to the short range communication circuit. In response to receiving such input, the short range communication circuit within enhanced ring 101 initiates a communication signal to paired device 102.

Paired device 102 receives the communication signal and, in response, initiates a predetermined transmission. In a first example, the predetermined transmission may include transmitting a message to the users of each of mobile phones 104a-104c. The message may include various information, such as a pre-recorded audio message, a location indication, an audio clip captured by paired device 102 or other device in communication with paired device 102 within a sliding window of receiving the communication signal, a video clip captured by paired device 102 or other connected device recorded in a time period after receiving the communication signal, and the like. The information that may be included within the message of the predetermined transmission from paired device 102 may be customizable.

It should be noted that the location indication may include a set of satellite coordinates detected from position broadcasts from global navigational satellite system (GNSS) satellite 106 (e.g., global positioning system (GPS), Galileo satellite system, BeiDou satellite system, GLONASS, and the like), or may include map coordinates associated with a mapping application, such as Google™ maps, Apple™ maps, and the like, which uses a combination of positional information, including one or more of positional information from GNSS satellite 106, positional information associated with WiFi™ access point 105 and/or base station 104

The predetermined transmission may be defined by user 100 or by another individual. Paired device 102 may include an interface that receives instructions to set the predetermined transmission. For example, user 100 may use a mobile application on a mobile phone (not shown) or a computing device (not shown) to program the predetermined transmission and then communicate the programmed predetermined transmission to paired device through an internet connection implemented via a WiFi™ connection, for example with WiFi™ access point 105, or via a data connection through the cellular-style communication network from base station 103.

In an additional example aspect, the paired device 102 may initiate the predetermined transmission without having first received the switch-enabled communication signal from enhanced ring 101. In such additional example aspect, as paired device 102 and enhanced ring 101 establish pairing over the short range wireless RAT, as noted above, confirmation signaling may be periodically transmitted using the short range wireless RAT between paired device 102 and enhanced ring 101 in order to confirm the pairing between paired device 102 and enhanced ring 101. In one example implementation, paired device 102 may periodically send a confirmation request signal to enhanced ring 101. Upon receipt of the confirmation request signal, enhanced ring 101 replies with a predetermined confirmation signal transmitted to paired device 102. In another example implementation, enhanced ring 101 may initiate the two-way confirmation signaling with paired device 102. In a further example implementation, enhanced ring 101 may periodically broadcast a confirmation signal to paired device 102. In such example implementation, paired device 102 would expect to receives such confirmation signal within a predetermined window of time.

As long as the confirmation signaling remains successful between paired device 102 and enhanced ring 101, paired device 102 waits to receive the switch-enabled communication signal to trigger sending the predetermined transmission. However, if the confirmation signaling fails at any point, such as when enhanced ring 101 is either moved to a location out of the range of the short range RAT, damaged, destroyed, or simply stops transmitting, paired device 102 will autonomously initiate the predetermined transmission.

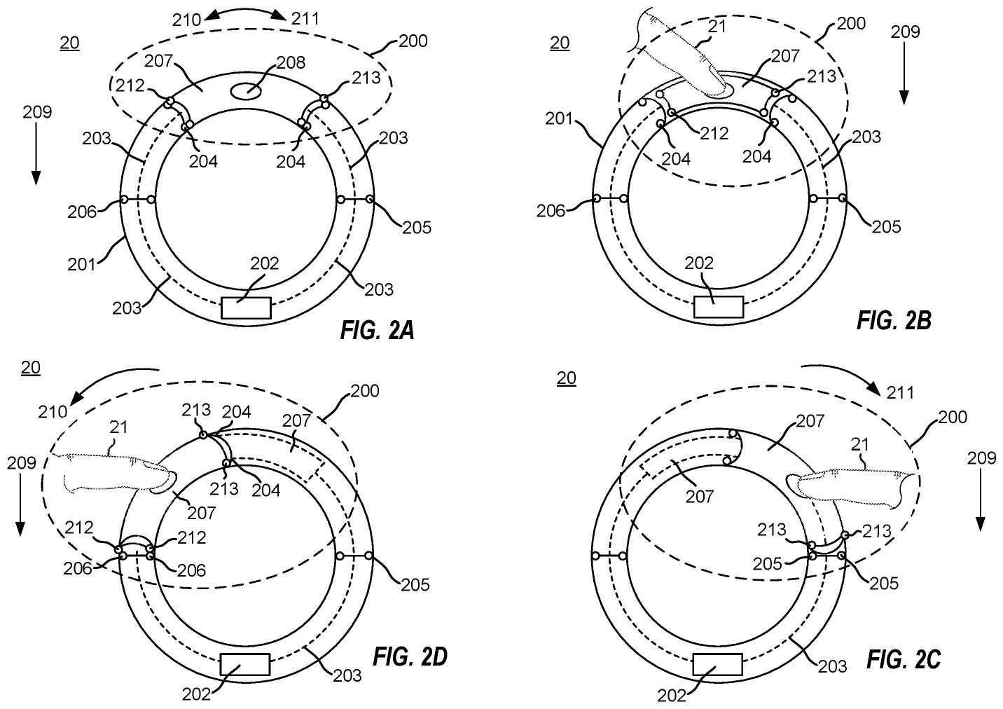

FIGS. 2A-2B are block diagrams illustrating enhanced ring 20 configured to provide switch-enabled communications according to one aspect of the present disclosure. Enhanced ring 20, as illustrated in FIG. 2A, includes a ring body 201, which may be made from any number of materials suitable for wearing on a human finger (e.g., precious metals, alloys, silicone, plastics, and the like), and a switch plate 207, which may be made from the same or different material as ring body 201. Ring body 201 includes electronics disposed inside of exterior layer of the material and a channel (within the area of ring body 201 identified by 200) in which switch plate 207 resides and may move based on a downward force 209 and lateral forces 210-211. Without downward force 209, the top side of switch plate 207 appears to be flush with the external surface of ring body 201. In such manner, switch plate 207 may be held in place by a deflectable component (not shown), such as a spring, cushion, deflectable material, and the like, which, in a relaxed state, exerts a stabilizing force in an opposite direction of downward force 209 and holds the top side of switch plate 207 flush with the external surface of ring body 201.

The electronics disposed inside of ring body 201 may include a short range communication circuit 202, which is configured to transmit short range signals, such as to paired device 102 (FIG. 1) and switch points 204-206 electronically coupled to short range communication circuit 202 via conductors 203. Switch plate 207 may further include a grip area 208 which identifies where a user may place his or her finger or thumb to move switch plate 207 to any of switch point 204-206 in order to activate switch-based communications from enhanced ring 20.

As illustrated in FIG. 2B, a user uses appendage 21, which may be a finger, thumb, toe, nose, or the like, to exert downward force 209 on to switch plate 207. Downward force 209 collapses the deflectable component holding switch plate 207 in place and places switch plate 207 into the plane of the channel at 200. Downward force 209 also disengages switch contacts 212 and 213 from switch points 204 in the circuit between switch points 204-206 and short range communication circuit 202. In the depressed state, the user may use appendage 21 to move switch plate 207 in either direction along the channel at 200 either toward switch point 205 or 206.

As illustrated in FIG. 2C, the user uses appendage 21 to exert lateral force 211 to move switch plate 207 along the channel at 200 to engage switch contact 213 of switch plate 207 with switch point 205. When switch contact 213 contact and completes the circuit with switch point 205, a first signal is provided to short range communication circuit 202. This first signal may correspond to a first predetermined message.

As illustrated in FIG. 2D, the user uses appendage 21 to exert lateral force 210 to move switch plate 207 along the channel at 200 to engage switch contact 212 of switch plate 207 with switch point 206. When switch contact 212 contact and completes the circuit with switch point 206, a second signal is provided to short range communication circuit 202. This second signal may correspond to a second predetermined message.

Enhanced ring 20, as illustrated in operation in FIGS. 2A-2D, implements a multi-positional switch, which may provide different information for different signals from enhanced ring 20 via short range communication circuit 202 to its paired device. The paired device may then interpret which signal is received and initiate a predetermined transmission that is associated with the type of signal received.

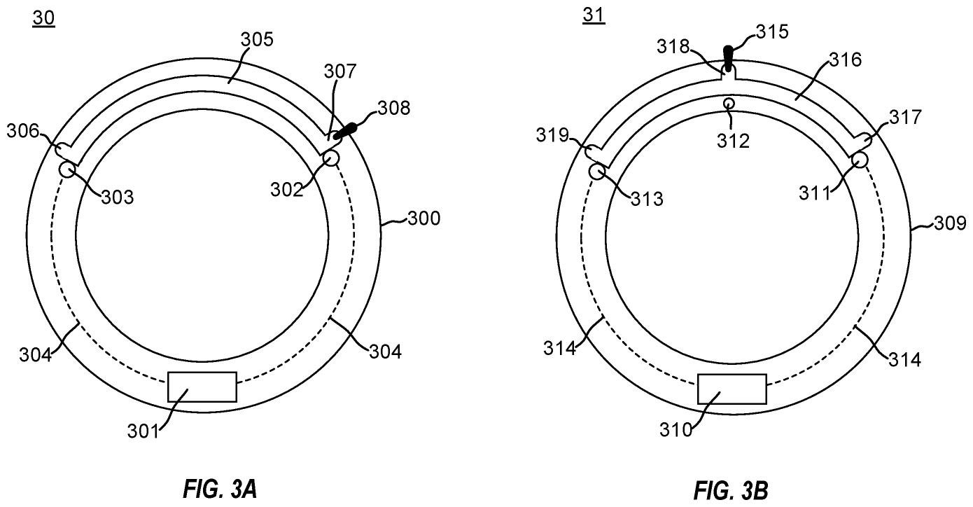

FIG. 3A is a block diagram illustrating enhanced ring 30 configured to conduct switch-enabled communications according to one aspect of the present disclosure. Enhanced ring 30 includes a ring body 300, which may be made from any number of materials suitable for wearing on a human finger, as noted above. Enhanced ring 30 may further include electronic components disposed on the interior of enhanced ring 30 including short range communication circuit 301 and switch points 302-303 coupled to short range communication circuit 301 via conductors 304. Switch lever 308 is moveable along channel 305 in a toggle switch format to engage with switch point 302 or switch point 303. In order to avoid accidental movement, detents 306 and 307 are formed in channel 305 to house switch lever 308 when no movement is desired. In one example implementation, switch lever 308 is fixed within channel 305 using a deflectable component that exerts a holding force on switch lever 308 into detents 306-307. In other example implementations, little or no holding force may be used to affix switch lever 308, but each of detents 306-307 may include a shape that switch lever 308 engages into, such as a pawl engaging the teeth of a gear, that holds switch lever 308 in place within detents 306 or 307.

A user wearing enhanced ring 30 may toggle switch lever 308, by moving switch lever 308 out of detent 307 and moving switch lever 308 across channel 305 and placing switch lever 308 into detent 306. The action of moving switch lever 308 from detent 307 to detent 306 causes movement of a circuit connection from switch point 302 to switch point 303. Closing of the circuit at switch point 302 signals short range communication circuit 301 to initiate a short range transmission to a paired device, such as paired device 102. As discussed above, the paired device may detect the signal and initiate a predetermined transmission.

In an additional aspect, the electronics included in the interior of enhanced ring 30 may include a vibrating/oscillating component (not shown) that may provide a haptic response to the user. For example, in order to signal the user that the desired signal will be or has been sent to the paired device, short range communication circuit 303 activates the vibrating/oscillating component to provide a haptic response to the user wearing enhanced ring 30. In one additional implementation, the vibrating/oscillating component may be configured to provide multiple patterns of haptic input. Thus, a different pattern of buzzing or tapping provided by the vibrating/oscillating component would represent to the user the particular type of signal requested by the user.

FIG. 3B is a block diagram illustrating enhanced ring 31 configured to conduct switch-enabled communications according to one aspect of the present disclosure. Enhanced ring 31 includes a ring body 309, which may be made from any number of materials suitable for wearing on a human finger, as noted above. Enhanced ring 31 may further include electronic components disposed on the interior of enhanced ring 31 including short range communication circuit 310 and switch points 311-313 coupled to short range communication circuit 310 via conductors 314. Switch lever 315 is moveable along channel 316 in a multi-positional switch format to engage with an of switch points 311-313. As implemented in enhanced ring 30 (FIG. 3A), enhanced ring 31 includes detents 317-319, which hold switch lever 315 in place when no movement or switch-activated communications are desired.

A user wearing enhanced ring 31 may toggle switch lever 315, by moving switch lever 315 out of detent 312 and moving switch lever 315 across channel 316 and placing switch lever 315 into either detent 317 or 319. The action of moving switch lever 315 from detent 312 to either of detents 317 or 319 may cause triggering of the multi-positional switch of a circuit connection from switch point 312 to either of switch points 311 or 313. Closing of the circuit at either of switch points 311 or 313 signal short range communication circuit 310 to initiate a short range transmission to a paired device, such as paired device 102. The content or structure of the short range transmission may be different depending on whether it is triggered by a signal based on the closed circuit at switch point 311 of switch point 313. As discussed above, the paired device may then interpret which signal is received and initiate a predetermined transmission that is associated with the type of signal received.

In a further example aspect of the operation of an enhanced ring configured for switched-enabled communications of the present disclosure, as illustrated in FIGS. 2A-2D and 3A-3B, the toggle/binary or multi-positional switch enabled enhanced rings (e.g., enhanced rings 20, 30, and 31) may also be configured for sequence-type switching. As such, instead of providing the ability to select a particular type of signaling associated with a single switch point, additional signaling may be selected by the user moving the switch (e.g., switch plate 207, switch lever 308, switch lever 315) in a predefined sequence.

Solely for purposes of describing such sequence, in one example implementation, a first optional signal may represent a desire of the user to call a ride-share car for transportation, a second optional signal may represent a desire of the user to find a friend within a gathering of people, such as in a restaurant, bar, nightclub, etc., a third optional signal may represent a request of the user for assistance due to a possible abduction. In order to select each of these optional signals, the user may move the switch in a particular sequence when there are not sufficient switch points to exclusively represent an associated signal.

For example, considering the toggle-type switch of enhanced ring 30, in order to call a ride-share car (first optional signal), the user may move switch lever from detent 307 to detent 306. In such example implementation, short range communication circuit 301 may include a microprocessor that monitors the signaling and sequence of signaling resulting from the closing of the circuits at switch points 302 and 303 and further includes logic that may interpret the type of signaling requested by the user and generating the corresponding short range signal for the paired device. Short range communication circuit 301 recognizes the sequence for the first optional signal and sends a signal to the paired device to transmit a request for a ride share car. When the user desires to find a friend in a bar where the user is (second optional signal), the user may move switch lever 308 from detent 307 to detent 306 and then back to detent 307. By sequentially closing the circuits at switch points 303 and 302, short range communication circuit 301 interprets the sequence to send the signal to the paired device to transmit a signal to the mobile device of a predetermined one or more contacts of the user. Finally, when the user desires help in a possible abduction circumstance (third optional signal), the user may move the switch lever 308 from detent 307 to detent 306 to detent 307 and then to detent 306. The particular multiple sequence of signaling by closing the circuits of switch points 302 and 303 may be determined by short range communication circuit 301 to send a signal to the paired device to send the predetermined transmission, which may include relevant position information, as described above, to one or more predetermined individuals or organizations (e.g., police, federal bureau of investigation (FBI), etc.).

It should be noted that the prior examples of sequential signaling are given purely as an example of how such sequential switching capability may be implemented. Any number of various actions, tasks, requests, and the like may be defined for any given optional signal, which may be fixed with the device by the manufacturer or programmable by the user or purchaser of the device. Moreover, the sequential signaling may be implemented on a binary, toggle-type switch (e.g., enhanced ring 30) or a multi-positional-type switch (e.g., enhanced ring 20 or 31). One consideration of implementing sequential signaling may be the complexity of the sequencing related to the capabilities of a user. For example, if the intended user is a child, a simple toggle-type switch (without sequential signaling enabled) or simple sequences may be defined, in order to increase the probability that the child can properly operate the switch-enabled communications. Alternatively, if the intended user is a typical adult, a highly-trained adult, or an individual with a sensory disability (e.g., blindness, deafness, unable to speak, etc.), a higher complexity set of sequenced signals may be defined and implemented by either a toggle-type switch or a multi-positional switch, where training or instruction is available for the individual user. The various aspects of switch-enabled communications according to the present disclosure are not limited to the specific examples used herein merely for demonstrational purposes.

The various implementations of the switch-enabled communications configured according to the aspects described herein may enable multiple different use cases that provide discrete, switch-enabled communications by the user wearing an enhanced ring along with maintaining a paired device within range of the enhanced ring. The following example use cases represent only a small number of scenarios in which the switch-enabled communications as described herein may be used. The described aspects of switch-enabled communications may be applicable to multiple different equivalent types of use cases.

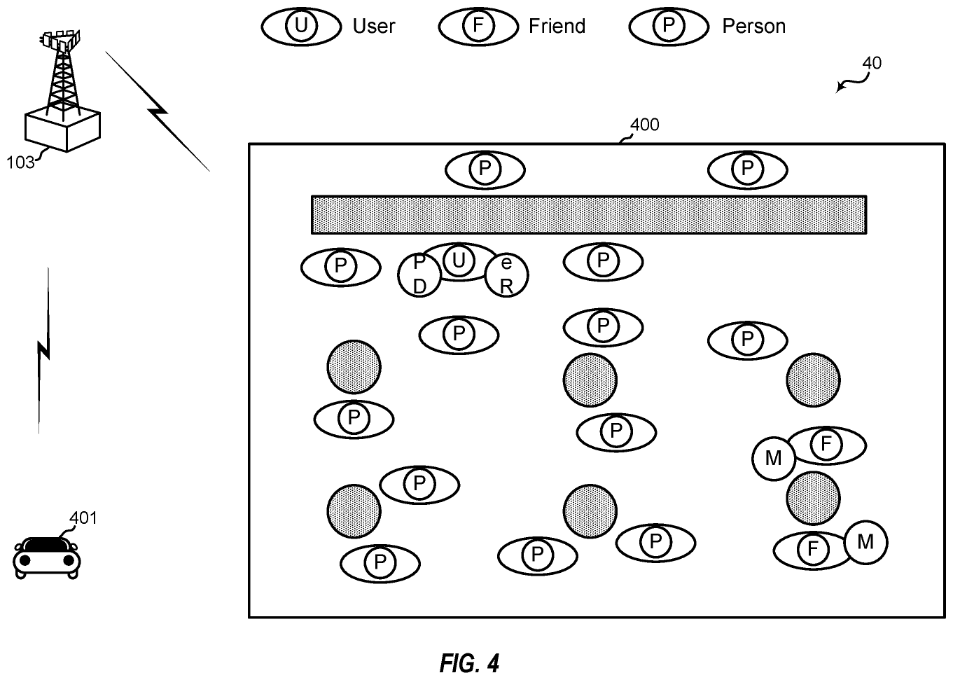

FIG. 4 is a block diagram illustrating a user, U, in possession of and wearing an enhanced ring, eR, and paired device, PD, configured for a switch-enabled communications system 40 according to one aspect of the present disclosure. The enhanced ring, eR, may be implemented according to enhanced rings 20, 30, and 31, as described and illustrated with regard to FIGS. 2A, 3A, and 3B, or may be implemented in any number of different equivalent formats to such illustrated enhanced rings. The user, U, may be located at an establishment 400, which may be a restaurant, bar, entertainment venue, home, or the like. For purposes of description of the example aspect, establishment 400 will be described as a bar. There are many people, P, at establishment 400, including the user, U, and the user's friends, F. At the instant of time illustrated, the user, U, is separated from the user's friends, F. For example, the user, U, may have arrived at the establish at a different time, may have left the vicinity of friends, F, or may not now that the user's friends, F, are located at establishment 400.

The user, U, desires to locate the user's friends, F. This may either be due to simply wanting to locate friends, F, or could be because the persons, P, surrounding the user, U, are making the user, U, feel uncomfortable. The user, U, may discretely move the switch on enhanced ring, eR, which sends a short range signal to the paired device, PD. In response to the received signal, the paired device, PD, makes a predetermined transmission to base station 103. The predetermined transmission may provide for a message to be sent from the paired device, PD, to the mobile devices, M, of the friends, F, via base station 103. The message to the friends, F, may allow the friends, F, to find the user, U.

In an additional or alternative aspect illustrated in FIG. 4, the user, U, may desire to call a ride-share service to request a ride away from establishment 400. In this additional or alternative aspect, the user, U, moves the switch in the enhanced ring, eR, which signals the paired device, PD, to send a request to a ride-sharing service for a ride-share car 401 via base station 103. In response to the signal, paired device, PD, would transmit a request message to the ride-share service via base station 103 including the user's, U, membership information and location. The ride-sharing service may then dispatch or offer the user's, U, service request to available ride-share cars, such as ride-share car 401. The user, U, may then walk out of establishment 400 to wait for ride-share car 401.

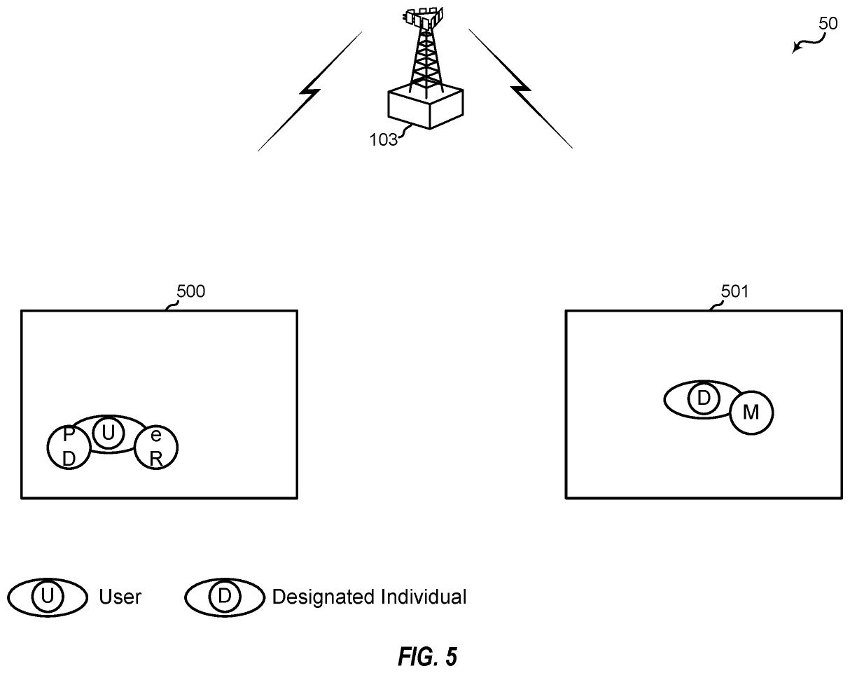

FIG. 5 is a block diagram illustrating a user, U, in possession of and wearing an enhanced ring, eR, and paired device, PD, configured for a switch-enabled communications system 50 according to one aspect of the present disclosure. As indicated above, the enhanced ring, eR, may be implemented according to enhanced rings 20, 30, and 31, as described and illustrated with regard to FIGS. 2A, 3A, and 3B, or may be implemented in any number of different equivalent formats to such illustrated enhanced rings. The user, U, may be an elderly person living on their own at home 500. In the instant illustrated in FIG. 5, the user, U, has fallen within home 500 and may either be injured, cannot get back up, or both. The user, U, is able to reach his or her finger to move the switch of enhanced ring, eR. By moving the switch of enhanced ring, eR, a short range signal is enabled from enhanced ring, eR, to the paired device, PD. In response to the short range signal, paired device, PD, sends a predetermined transmission to a designated individual, D, via base station 103. The contact information and designation of designated individual, D, may have been pre-programmed into the switch-enabled communication logic within paired device, PD. The designated individual, D, may be located at his or her residence, work, or in another room in the same facility as home 500. After receiving the predetermined transmission, designated individual, D, may go to home 500 to assist the user, U.

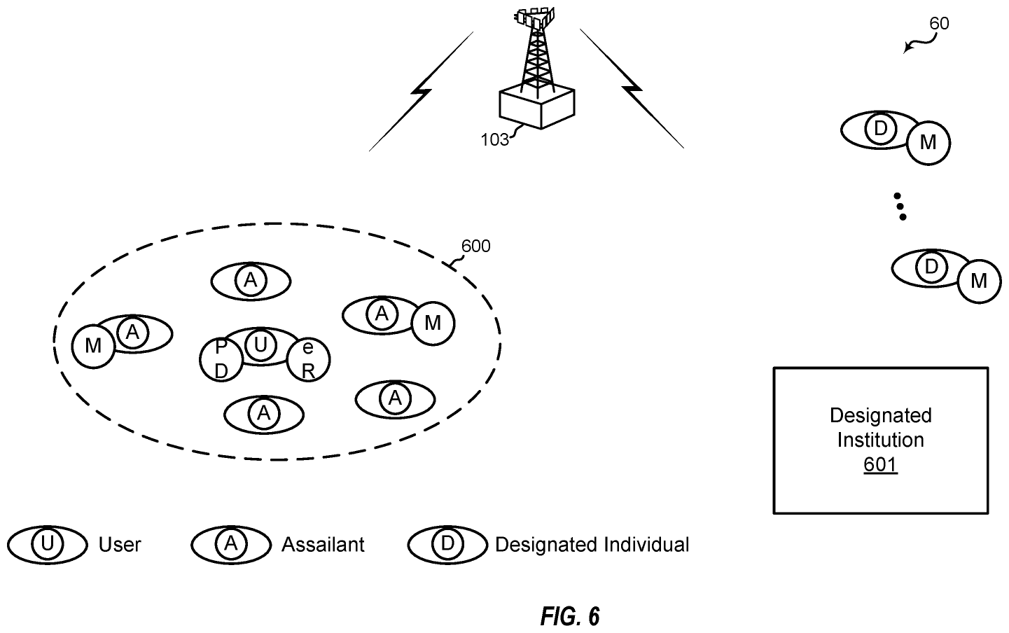

FIG. 6 is a block diagram illustrating a user, U, in possession of and wearing an enhanced ring, eR, and paired device, PD, configured for a switch-enabled communications system 60 according to one aspect of the present disclosure. As indicated above, the enhanced ring, eR, may be implemented according to enhanced rings 20, 30, and 31, as described and illustrated with regard to FIGS. 2A, 3A, and 3B, or may be implemented in any number of different equivalent formats to such illustrated enhanced rings. The user, U, may be in a potential or real abduction situation with assailants, A. The assailants, A, bind the hands of the user, U, together and move the user, U, to a different location. With hands bound together, the user, U, may still have the capability to move a finger or thumb to the switch of enhanced ring, eR. With discrete motion, the user, U, moves the switch on enhanced ring, eR, to provide a short range signal to the paired device, PD. In response to receiving the short range signal, the paired device, PD, sends a predetermined transmission via base station 103. The predetermined transmission includes location data, identification information of the user, U, and is configured to be addressed to a number of designated individuals, D, a designated institution 601, such as the police, the FBI, etc.), and the like. Therefore, the paired device, PD, sends the predetermined transmission to the designated individuals, D, and designated institution 601 via base station 103.

In additional aspects of the present disclosure as illustrated in FIG. 6, the predetermined transmission may be transmitted to the designated individuals, D, and designated institution 601 using an emergency priority transmission capability. For example, as the predetermined transmission arrives at the mobile devices, M, of the designated individuals, D, it triggers the same components of the mobile device, M, that would be triggered by broadcast Wireless Emergency Alerts (WEA) type communications, such as Amber Alerts, emergency weather alerts, presidential alerts, and the like. Thus, as the predetermined transmission arrives, the mobile devices, M, may indicate loud, audible, alerts regardless of whether the mobile device, M, is currently set to silent or not. Alternatively, where current emergency communications regulations, such as Warning, Alert and Response Network (WARN) Act, enable individually-addressed warning transmissions, the predetermined transmission may be identified with a high priority supported by such emergency response communications capabilities.

In further additional aspects of the present disclosure as illustrated in FIG. 6, when the paired device, PD, receives the short range signal from the enhanced ring, eR, of the user, U, the paired device, PD, establishes a peer-to-peer (P2P) communication connection with any mobile devices, D, of the assailants, A, within a proximal range 600. Such P2P communication connection may occur via a short range RAT (e.g., WiFi™, Bluetooth™, Bluetooth™ LE, etc.), or via a sidelink communication standard, such as for LTE or 5G NR-enabled devices. The paired device, PD, may use such P2P communication connection to obtain additional location information, device identification information of the particular mobile device, M, such as the device mobile identification number (MIN), international mobile equipment identity (IMEI) number, and the like. All of this information may be compiled into the predetermined transmission to bolster location information and potential identification information of the assailants, A. When connected via a long range mobile RAT, such as via an LTE or 5G NR-enabled sidelink connection, the P2P communication connection may also be used to combine the paired device, PD, and the mobile devices, M, of the assailants, A, into a virtual mobile device having additional quasi-colocated transmission antennas for cooperative transmission of the predetermined transmission. Such cooperative transmission aspects of the virtual mobile device would likely increase the reliability of the transmission of the predetermined transmission.

In further additional aspects of the present disclosure as illustrated in FIG. 6, once the user, U, moves the switch on enhanced ring, eR, and sends the short range signal that triggers the paired device, PD, sending the predetermined transmission, the paired device, PD, will periodically send an updated predetermined transmission using any updated location information or identification information gathered when the paired device, PD, makes the updated predetermined transmission. Therefore, if the assailants, A, are moving the user, U, to different locations, the paired device, PD, will send updated information on the location of the user, U, and any additional identification of the assailants, A, within the proximal range 600 of the user, U.

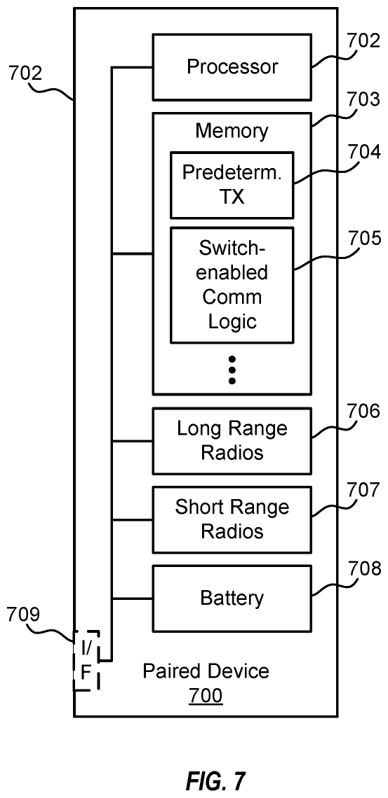

FIG. 7 is a block diagram illustrating an example implementation of paired device 700 configured to provide switch-enabled communications according to one aspect of the present disclosure. Paired device 700 includes a form factor 702. Form factor 702 provides the housing for the interior electronics of paired device 700. Form factor 702 may include any number of forms, such as a bracelet, a necklace, a pendant, an earring, a block, a puck, and the like. Form factor 702 may be selected as a wearable device or a mobile device similar, but separate from, a mobile phone that a user would carry on their person. Within form factor 702, paired device includes a number of electronic components that enable both short range and long range communications as well as processing capabilities for processing and storing input from a user.

Paired device 700 includes a processor 702, memory 703, long range radios 706, short range radios 707, and battery 708. Paired device 700 may also include an interface 709, which would provide a wired connection into the electronics of paired device 700 that could be used for inputting information and preferences regarding the predetermined transmissions, as well as for charging battery 708. Memory 703 may include predetermined transmission 704, which holds the details for the predetermination transmission, including location information, destinations for designated individuals, and the like, a switch-enabled communication logic 705, which, upon execution with processor 702, provides the functionality for paired device 700 to conduct both short range communications, using short range radios 707, with an enhanced ring, and long term communications, using long range radios.

The provision of switch-enabled communications capabilities may occur by paired device 700 executing, under control of processor 702, the code and logic steps of switch-enabled communication logic 705 (referred to herein as the “execution environment” of switch-enabled communication logic 705). Within the execution environment of switch-enabled communication logic 705, paired device 700 may receive a short range signal from an enhanced ring, to which paired device 700 is paired, via short range radios 707. Depending on the implementation of switch-enabled communications being handled by paired device 700, the short range signal may simply trigger a single predetermined transmission or may represent one of many predetermined transmission. If implementing the multiple predetermined transmission aspect, processor 702, within the execution environment of switch-enabled communication logic 705 determines which of the predetermined transmission within predetermined transmission 704 the signal identifies. Once identified, paired device 700 then sends the identified predetermined transmission to the designated individuals via long range radios 706.

In order to program or provide the information regarding designated individuals, identification information for the user, and the like, a user may either connect a computer directly to paired device via interface 709 or may access an application on a computer or mobile device that wirelessly connects to paired device 700, either via long range radios 706 or short range radios 707, or accesses a web page or web application with a computer or mobile device that also wirelessly connects to paired device 700, again, either via long range radios 706 or short range radios 707. The user or purchaser of paired device may input such information to predetermined transmission 704 within memory 703.

Each of the components incorporated into paired device 700 may implement the various aspects of the present disclosure as described and illustrated with respect to FIGS. 1 and 4-6.

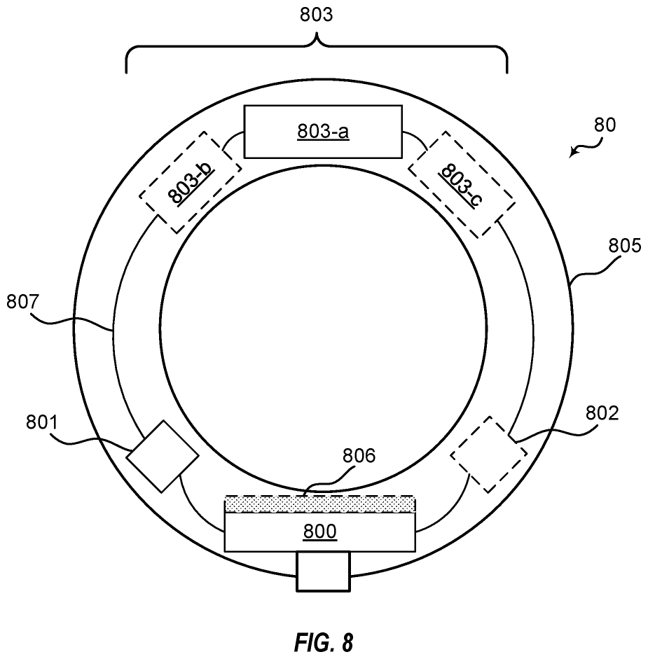

FIG. 8 is a block diagram illustrating an example implementation of enhanced ring 80 configured to provide switch-enabled communications according to one aspect of the present disclosure. Enhanced ring 80 includes ring housing 805. Ring housing 805 creates the structure of the ring for the user to wear. Ring housing 805 may be made from any variety of suitable materials and formats that allow electronics to be placed on the inside of ring housing 805. The electronics may be placed within a hollowed cavity within ring housing 805 or may by assembled and then have the material of ring housing 805 formed or molded around the electronics. The specific format or construction of ring housing 805 is not limited according to any specific implementation described herein for purposes of example.

Enhanced ring 80 includes a switch 800 accessible by a user to close circuits at a switch point, including switch point 801, when implemented as a toggle-type switch. In implementations of multi-positional switches, enhanced ring 80 may also include one or more additional switch points 802. The various switch points, such as switch points 801 and 802, are coupled, via conductors 807 to short range communication circuit 803. Depending on the complexity of the implementation that enhanced ring 80 is configured, short range communication circuit 803 may include a short range radio 803-a, or if more complexity is enabled, may include a battery 803-b, or advanced processor 803-c, which may include a microprocessor and memory for identifying multiple switch signal indications or sequences and their associated short range signal that will be transmitted by short range radio 803-a.

In certain implementations of enhanced ring 80, switch 800 may be positioned within ring housing using deflectable material 806. Deflectable material 806 provides deflectable force in holding switch 800 in certain positions in order to assist the user in activating switch 800 or in preventing unwanted or accidental activation or switch 800.

In additional example implementations of enhanced ring 80, a haptic device 808, such as an oscillator or vibrating element, may provide haptic response to the user via ring housing 805 in response to transmission of the activation signal. In example implementations where multiple different activation signals may be transmitted to trigger different predetermined transmissions from the paired device, haptic device 808 may provide a distinct haptic pattern to the user to identify which predetermined transmission will be activated.

Each of the components incorporated into enhanced ring 80 may implement the various aspects of the present disclosure as described and illustrated with respect to FIGS. 1, 2A-2D, 3A-3B, and 4-6.

FIG. 9 is a block diagram illustrating example blocks executed by a virtual communication device including an enhanced ring and a paired device and configured to provide switch-enabled communications according to aspects of the present disclosure. The virtual communication may include the enhanced ring, with a physical switch interface, and the paired device, wirelessly paired to the enhanced ring, wherein the enhanced ring and the paired device are, at least initially, maintained on a body of a user.

At block 900, the enhanced ring detects a physical switch input from the user at the physical switch interface, wherein the physical switch input is indicative of activation of the switch-enabled communication. The physical switch interface may include just two switch points or multiple switch points. The enhanced ring may then detect between the one of two switch points, the one of many switch points, or a sequence of switching or movement between either the just two switch points or the multiple switch points.

At block 901, the enhanced ring exchanges, via a short-range RAT, an activation signal with the paired device of the virtual communication device (e.g., virtual communication device 108 (FIG. 1)), wherein the activation signal indicates activation of the switch-enabled communication. When the physical switch interface provides just two switch points, the enhanced ring will identify when the other switch point is activated and then transmit the activation signal. Where multiple switch points are available or an implementation configures detection of a sequence detection, the enhanced ring would select one activation signal among a plurality of candidate activation signals associated with a specific predetermined transmission.

At block 902, the paired device transmits, via a long-range RAT, a predetermined transmission to one or more designated recipients in response to the activation signal. When the physical switch interface provides just two switch points, the paired device transmits the single predetermined transmission to the designated recipients. Otherwise, where multiple switch points are available or the enhanced ring may determine different sequences of movement, the paired device will transmit a selected predetermined transmission from a plurality of candidate predetermined transmissions associated with the particular activation signal received from the enhanced ring.

It should be noted that the enhanced rings that may be compatible with and configured for switch-enabled communications according to the various aspects described herein may be made from any number of materials suitable for wearing on a human finger (e.g., precious metals, alloys, silicone, plastics, and the like). Such materials would encapsulate or cover the internal electronics of the short-range communication circuit. The materials may be selected based on a desired style, a desired feature such as water-resistance and water-proofing (e.g., as may sometimes be identified in electronics, such as mobile phones, by various ingress protection codes implemented by the International Electrotechnical Commission (IEC), including IP67, IP68, etc.), low-cost, and the like.

In some example implementations, the electronics implementing the short-range communication circuit of the enhanced ring may be encapsulated using low pressure molding (LPM) with appropriate materials, such as polyamide, polyolefin, and other appropriate polymers. The outer surface of such an enhanced ring would be the LPM material. In another example implementation, the outer surface of the ring may be a precious metal, such as gold, silver, platinum, and the like, with the electronics of the short-range communication circuit being placed within a hollowed cavity in the precious metal or, depending on the type of precious metal and its melting point, could be molded around the electronics. In such a precious metal molding implementation, the electronics may first be encapsulated in a polymer via an LPM process, in which the selected polymer exhibits a resistance to the level of heat used to melt the precious metal for molding. A further example implementation may include the electronics being encapsulated in a first low-cost metallic material and then coated with another layer of precious metal via an electroplating or similar process. The various aspects of the present disclosure are not limited to any particular process or material for manufacturing the enhanced ring.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIG. 9 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both incorporated into the described paired device and enhanced ring, respectively. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various aspects of the present disclosure may be implemented in many different ways, including methods, processes, non-transitory computer-readable medium having program code recorded thereon, apparatus having one or more processors with configurations and instructions for performing the described features and functionality, and the like. In a first aspect configured for switch-enabled communication by a virtual communication device including an enhanced ring, with a physical switch interface, and a paired device, wirelessly paired to the enhanced ring, wherein the enhanced ring and the paired device are, at least initially, maintained on a body of a user, may include detecting a physical switch input from the user at the physical switch interface, wherein the physical switch input is indicative of activation of the switch-enabled communication; exchanging, via a short-range RAT, an activation signal between the enhanced ring and the paired device of the virtual communication device, wherein the activation signal indicates activation of the switch-enabled communication; and transmitting, via a long-range RAT, a predetermined transmission from the paired device to one or more designated recipients in response to the activation signal.

In a second aspect, alone or in combination with the first aspect, wherein the enhanced ring includes a first short-range communication circuit configured for the exchanging the activation signal, and wherein the paired device includes a second short-range communication circuit configured for the exchanging the activation signal and a first long-range communication circuit configured for the transmitting the predetermined transmission.

In a third aspect, alone or in combination with one or more of the first aspect or the second aspect, wherein the detecting the physical switch input includes one of: detecting movement of the physical switch interface between one of two switch points; or detecting movement of the physical switch interface between one of a plurality of switch points; or detecting a sequence of movement of the physical switch interface between one of: the two switch points or the plurality of switch points.

In a fourth aspect, alone or in combination with one or more of the first aspect through the third aspect, wherein the activation signal includes one of: a single activation signal triggered in response to the detecting the movement of the physical switch interface between the one of two switch points, wherein the single activation signal flags activation of the switch-enabled communication to the paired device; a selected activation signal from a plurality of predetermined candidate activation signals selected in response to the detecting one of: the movement of the physical switch interface between the one of the plurality of switch points, or the sequence of movement of the physical switch interface between the one of: the two switch points or the plurality of switch points, wherein each candidate activation signal of the plurality of predetermined candidate activation signals is one of: a distinct predetermined action, or distinct predetermined information.

In a fifth aspect, alone or in combination with one or more of the first aspect through the fourth aspect, wherein predetermined transmission includes a selected predetermined transmission from a plurality of candidate predetermined transmissions, wherein each of the plurality of candidate predetermined transmissions is associated with one of the plurality of predetermined candidate activation signals.

In a sixth aspect, alone or in combination with one or more of the first aspect through the fifth aspect, wherein each of the plurality of candidate predetermined transmissions includes one or more of: request of a service for the user; identification of an emergency situation; identification of one of information or communication of the user; or indicating presence of the user to the one or more designated recipients.

In a seventh aspect, alone or in combination with one or more of the first aspect through the sixth aspect, further including: providing, by the enhanced ring, a haptic response to the user in response to the exchanging of the activation signal.

In an eighth aspect, alone or in combination with one or more of the first aspect through the seventh aspect, wherein the haptic response includes one of a plurality of haptic response patterns associated with the each candidate activation signal of the plurality of predetermined candidate activation signals.

In a ninth aspect, alone or in combination with one or more of the first aspect through the eighth aspect, wherein the predetermined transmission includes transmission data that includes one or more of: ID information associated with the user; location data; video data; audio data; image data; orientation information of one or more of the enhanced ring and the paired device; direction information of movement of one or more of the enhanced ring and the paired device; or ID information associated with one or more neighboring wireless user devices in proximity to the paired device.

In a tenth aspect, alone or in combination with one or more of the first aspect through the ninth aspect, wherein the location data includes one or more of: GNSS coordinates obtained from one of: a GNSS receiver at the paired device, the one or more neighboring wireless user devices, a neighboring cellular base station in communication with the paired device, or a neighboring wireless access point in communication with the paired device; and location information associated with one of the neighboring cellular base station or the neighboring wireless access point.

In an eleventh aspect, alone or in combination with one or more of the first aspect through the tenth aspect, further including: establishing a P2P connection between the paired device and one or more external devices including one or more of: one or more neighboring mobile devices, one or more wireless access points, and one or more cellular base stations; and retrieving, by the paired device, one or more portions of the transmission data from the one or more external devices.

In a twelfth aspect, alone or in combination with one or more of the first aspect through the eleventh aspect, wherein the transmitting the predetermined transmission includes transmission via the paired device and one or more of the one or more external devices within the P2P connection with the paired device.

In a thirteenth aspect, alone or in combination with one or more of the first aspect through the twelfth aspect, further including: transmitting, via the long-range RAT, an updated predetermined transmission from the paired device to the one or more designated recipients in response to expiration of an update timer, wherein the updated predetermined transmission includes updated transmission data regarding the user.

In a fourteenth aspect, alone or in combination with one or more of the first aspect through the thirteenth aspect, further including: identifying common ID information associated with one or more devices of the one or more neighboring wireless user devices in proximity to the paired device at expiration of the update time that is common to the ID information associated with the one or more neighboring wireless user devices in proximity to the paired device at transmission of the predetermined transmission; and resending the common ID information within the updated predetermined transmission.

In a fifteenth aspect, alone or in combination with one or more of the first aspect through the fourteenth aspect, wherein one or more of the predetermined transmission and the updated predetermined transmission are transmitted using a priority emergency transmission protocol.

In a sixteenth aspect, alone or in combination with one or more of the first aspect through the fifteenth aspect, further including: periodically exchanging one or more confirmation signals between the enhanced ring and the paired device while wirelessly paired; detecting, by the paired device, a failure of the one or more confirmation signals from the enhanced ring; and transmitting, via the long-range RAT, the predetermined transmission from the paired device to the one or more designated recipients in response to the failure.

In a seventeenth aspect, alone or in combination with one or more of the first aspect through the sixteenth aspect, wherein the failure includes one of: failure of a single confirmation signal of the one or more confirmation signals from the enhanced ring; or failure of a predetermined number of confirmation signals of the one or more confirmation signals from the enhanced ring.

In an eighteenth aspect of a paired device configured for switch-enabled communication, may include one or more processors; a long-range communication radio coupled to the one or more processors; a short-range communication radio coupled to the one or more processors; a memory coupled to the one or more processors including logic stored thereon to configure switch-enabled communication, wherein the logic, when executed by the one or more processors, configures the paired device: to establish wireless pairing with an enhanced ring via the short-range communication radio; to monitor for an activation signal from the enhanced ring via the short-range communication radio; and to transmit a predetermined transmission via the long-range communication radio to one or more designated recipients in response to the activation signal; and a form factor encapsulating the one or more processors, the long-range communication radio, the short-range communication radio, and the memory.

In a nineteenth aspect, alone or in combination with the eighteenth aspect, further including: a rechargeable power source coupled to the one or more processors, the long-range communication radio, the short-range communication radio, and the memory; and an interface configured to receive input to define one or more of the predetermined transmission and the one or more designated recipients.

In a twentieth aspect, alone or in combination with one or more of the eighteenth aspect through the nineteenth aspect or the eighteenth aspect, wherein the interface is configured to receive the input one of via a physical link with a computing device; or via a wireless link with one of a computing device or an internet application.

In a twenty-first aspect of an enhanced ring configured for switch-enabled communication may include one or more processors; a short-range communication radio coupled to the one or more processors; a physical switch interface accessible by a user; a memory coupled to the one or more processors including logic stored thereon to configure switch-enabled communication, wherein the logic, when executed by the one or more processors, configures the paired device: to establish wireless pairing with a paired device via the short-range communication radio; to detect physical switch input of the physical switch interface, wherein the physical switch input is indicative of activation of the switch-enabled communication; to transmit an activation signal associated with the physical switch input via the short-range communication radio to the paired device in response to the physical switch input; and a ring housing encapsulating the one or more processors, the short-range communication radio, and the memory, wherein the physical switch interface is accessible by the user through the ring housing.

In a twenty-second aspect, alone or in combination with the twenty-first aspect, wherein the physical switch interface includes one of: two selectable switch positions or three or more selectable switch positions.

In a twenty-third aspect, alone or in combination with the twenty-second aspect or the twenty-first aspect, wherein the logic, when executed by the one or more processors, further configures the paired device to receive configuration information of the switch-enabled communication from the paired device via the short-range communication radio.

In a twenty-fourth aspect, alone or in combination with one or more of the twenty-first aspect through the twenty-third aspect, further including: a deflectable material positioned to exert a holding force on the physical switch interface, wherein the deflectable material provides moveable control to the user for the physical switch input.

In a twenty-fifth aspect, alone or in combination with one or more of the twenty-first aspect through the twenty-fourth aspect, further including: a power source coupled to the one or more processors, the short-range communication radio, and the memory.

In a twenty-sixth aspect, alone or in combination with one or more of the twenty-first aspect through the twenty-fifth aspect, further including: an haptic device coupled to the one or more processors, wherein the one or more processors controls the haptic device to signal a haptic response to the ring housing in response to the activation signal.

In a twenty-seventh aspect of switch-enabled communication performed by a paired device may include establishing wireless pairing with an enhanced ring via a short-range communication radio of the paired device; monitoring, by the paired device, for an activation signal from the enhanced ring via the short-range communication radio; and transmitting, by the paired device, a predetermined transmission via a long-range communication radio of the paired device to one or more designated recipients in response to detection of the activation signal.

In a twenty-eighth aspect, alone or in combination with the twenty-seventh aspect, wherein the activation signal includes one of: a single activation signal triggering the transmitting the predetermined transmission; or a selected activation signal from a plurality of predetermined candidate activation signals, wherein each candidate activation signal of the plurality of predetermined candidate activation signals is one of: a distinct predetermined action, or distinct predetermined information.

In a twenty-ninth aspect, alone or in combination with the twenty-eighth aspect or the twenty-seventh aspect, wherein predetermined transmission includes a selected predetermined transmission from a plurality of candidate predetermined transmissions, wherein each of the plurality of candidate predetermined transmissions is associated with one of the plurality of predetermined candidate activation signals.

In a thirtieth aspect, alone or in combination with one or more of the twenty-seventh aspect through the twenty-ninth aspect, wherein each of the plurality of candidate predetermined transmissions includes one or more of: request of a service for the user; identification of an emergency situation; identification of one of information or communication of the user; or indicating presence of the user to the one or more designated recipients.

In a thirty-first aspect, alone or in combination with one or more of the twenty-seventh aspect through the thirtieth aspect, wherein the predetermined transmission includes transmission data that includes one or more of: ID information associated with a user of the enhanced ring; location data; video data; audio data; image data; orientation information of one or more of the enhanced ring and the paired device; direction information of movement of one or more of the enhanced ring and the paired device; or ID information associated with one or more neighboring wireless user devices in proximity to the paired device.

In a thirty-second aspect, alone or in combination with one or more of the twenty-seventh aspect through the thirty-first, wherein the location data includes one or more of: GNSS coordinates obtained by the paired device from one of: a GNSS receiver at the paired device, the one or more neighboring wireless user devices, a neighboring cellular base station in communication with the paired device, or a neighboring wireless access point in communication with the paired device; and location information associated with one of the neighboring cellular base station or the neighboring wireless access point.

In a thirty-third aspect, alone or in combination with one or more of the twenty-seventh aspect through the thirty-second aspect, further including: establishing, by the paired device, a P2P connection with one or more external devices including one or more of: one or more neighboring mobile devices, one or more wireless access points, and one or more cellular base stations; and retrieving, by the paired device, one or more portions of the transmission data from the one or more external devices.

In a thirty-fourth aspect, alone or in combination with one or more of the twenty-seventh aspect through the thirty-third aspect, wherein the transmitting the predetermined transmission includes transmission via the paired device and one or more of the one or more external devices within the P2P connection with the paired device.

In a thirty-fifth aspect, alone or in combination with one or more of the twenty-seventh aspect through the thirty-fourth aspect, further including: transmitting, by the paired device via the long-range RAT, an updated predetermined transmission to the one or more designated recipients in response to expiration of an update timer, wherein the updated predetermined transmission includes updated transmission data regarding the user.

In a thirty-sixth aspect, alone or in combination with one or more of the twenty-seventh aspect through the thirty-fifth aspect, further including: identifying, by the paired device, common ID information associated with one or more devices of the one or more neighboring wireless user devices in proximity to the paired device at expiration of the update time that are common to the ID information associated with the one or more neighboring wireless user devices in proximity to the paired device at transmission of the predetermined transmission; and resending the common ID information within the updated predetermined transmission.

In a thirty-seventh aspect, alone or in combination with one or more of the twenty-seventh aspect through the thirty-sixth aspect, wherein one or more of the predetermined transmission and the updated predetermined transmission are transmitted by the paired device using a priority emergency transmission protocol.

In a thirty-eighth aspect, alone or in combination with one or more of the twenty-seventh aspect through the thirty-seventh aspect, further including: periodically exchanging one or more confirmation signals between the enhanced ring and the paired device while wireless paired; detecting, by the paired device, a failure of the one or more confirmation signals from the enhanced ring; and transmitting, by the paired device via the long-range RAT, the predetermined transmission to the one or more designated recipients in response to the failure.

In a thirty-ninth aspect, alone or in combination with one or more of the twenty-seventh aspect through the thirty-eighth aspect, wherein the failure includes one of: failure of a single confirmation signal of the one or more confirmation signals from the enhanced ring; or failure of a predetermined number of confirmation signals of the one or more confirmation signals from the enhanced ring.

In a fortieth aspect of switch-enabled communication performed by an enhanced ring may include establishing wireless pairing with a paired device via a short-range communication radio of the enhanced ring; detecting, by the enhanced ring, physical switch input of a physical switch interface of the enhanced ring, wherein the physical switch input is indicative of activation of the switch-enabled communication; and transmitting, by the enhanced ring via the short-range communication radio, an activation signal associated with the physical switch input to the paired device in response to the physical switch input.

In a forty-first aspect, alone or in combination with the fortieth aspect, wherein the detecting the physical switch input includes one of detecting movement of the physical switch interface between one of two switch points; or detecting movement of the physical switch interface between one of a plurality of switch points; or detecting a sequence of movement of the physical switch interface between one of: the two switch points or the plurality of switch points.

In a forty-second aspect, alone or in combination with one or more of the fortieth aspect or the forty-first aspect, wherein the activation signal includes one of: a single activation signal triggered in response to the detecting the movement of the physical switch interface between the one of two switch points, wherein the single activation signal flags activation of the switch-enabled communication to the paired device; a selected activation signal from a plurality of predetermined candidate activation signals selected in response to the detecting one of: the movement of the physical switch interface between the one of the plurality of switch points, or the sequence of movement of the physical switch interface between the one of: the two switch points or the plurality of switch points, wherein each candidate activation signal of the plurality of predetermined candidate activation signals is one of: a distinct predetermined action, or distinct predetermined information.

In a forty-third aspect, alone or in combination with one or more of the fortieth aspect through the forty-second aspect, further including: providing, by the enhanced ring, a haptic response to the user in response to the exchanging of the activation signal.

In a forty-fourth aspect, alone or in combination with one or more of the fortieth aspect through the forty-third aspect, wherein the haptic response includes one of a plurality of haptic response patterns associated with the each candidate activation signal of the plurality of predetermined candidate activation signals.

In a forty-fifth aspect, alone or in combination with one or more of the fortieth aspect through the forty-fourth aspect, further including: periodically exchanging, by the enhanced ring, one or more confirmation signals with the paired device while wirelessly paired.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine that may be implemented in the form factor of the enhanced ring and paired device. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, or any other suitable form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of switch-enabled communication by a virtual communication device including an enhanced ring, with a physical switch interface, and a paired device, wirelessly paired to the enhanced ring, wherein the enhanced ring and the paired device are, at least initially, maintained on a body of a user, the method comprising:
detecting a physical switch input from the user at the physical switch interface, wherein the physical switch input is indicative of activation of the switch-enabled communication;
exchanging, via a short-range radio access technology (RAT), an activation signal between the enhanced ring and the paired device of the virtual communication device, wherein the activation signal indicates activation of the switch-enabled communication; and
transmitting, via a long-range RAT, a predetermined transmission from the paired device to one or more designated recipients in response to the activation signal.

2. The method of claim 1,
wherein the enhanced ring includes a first short-range communication circuit configured for the exchanging the activation signal, and
wherein the paired device includes a second short-range communication circuit configured for the exchanging the activation signal and a first long-range communication circuit configured for the transmitting the predetermined transmission.

3. The method of claim 1, wherein the detecting the physical switch input includes one of:
detecting movement of the physical switch interface between one of two switch points; or
detecting movement of the physical switch interface between one of a plurality of switch points; or
detecting a sequence of movement of the physical switch interface between one of: the two switch points or the plurality of switch points.

4. The method of claim 3, wherein the activation signal includes one of:
a single activation signal triggered in response to the detecting the movement of the physical switch interface between the one of two switch points, wherein the single activation signal flags activation of the switch-enabled communication to the paired device; or
a selected activation signal from a plurality of predetermined candidate activation signals selected in response to the detecting one of: the movement of the physical switch interface between the one of the plurality of switch points, or the sequence of movement of the physical switch interface between the one of: the two switch points or the plurality of switch points, wherein each candidate activation signal of the plurality of predetermined candidate activation signals is one of: a distinct predetermined action, or distinct predetermined information.

5. The method of claim 4, wherein predetermined transmission includes a selected predetermined transmission from a plurality of candidate predetermined transmissions, wherein each of the plurality of candidate predetermined transmissions is associated with one of the plurality of predetermined candidate activation signals.

6. The method of claim 5, wherein each of the plurality of candidate predetermined transmissions includes one or more of:
request of a service for the user;
identification of an emergency situation;
identification of one of information or communication of the user; or
indicating presence of the user to the one or more designated recipients.

7. The method of claim 3, further including:
providing, by the enhanced ring, a haptic response to the user in response to the exchanging of the activation signal.

8. The method of claim 7, wherein the haptic response includes one of a plurality of haptic response patterns associated with the each candidate activation signal of the plurality of predetermined candidate activation signals.

9. The method of claim 1, wherein the predetermined transmission includes transmission data that includes one or more of:
identification (ID) information associated with the user;
location data;
video data;
audio data;
image data;
orientation information of one or more of the enhanced ring and the paired device;
direction information of movement of one or more of the enhanced ring and the paired device; or
ID information associated with one or more neighboring wireless user devices in proximity to the paired device.

10. The method of claim 9, wherein the location data includes one or more of:
global navigational satellite system (GNSS) coordinates obtained from one of: a GNSS receiver at the paired device, the one or more neighboring wireless user devices, a neighboring cellular base station in communication with the paired device, or a neighboring wireless access point in communication with the paired device; and
location information associated with one of the neighboring cellular base station or the neighboring wireless access point.

11. The method of claim 9, further including:
establishing a peer-to-peer (P2P) connection between the paired device and one or more external devices including one or more of: one or more neighboring mobile devices, one or more wireless access points, and one or more cellular base stations; and
retrieving, by the paired device, one or more portions of the transmission data from the one or more external devices.

12. The method of claim 11, wherein the transmitting the predetermined transmission includes transmission via the paired device and one or more of the one or more external devices within the P2P connection with the paired device.

13. The method of claim 11, further including:
transmitting, via the long-range RAT, an updated predetermined transmission from the paired device to the one or more designated recipients in response to expiration of an update timer, wherein the updated predetermined transmission includes updated transmission data regarding the user.

14. The method of claim 13, further including:
identifying common ID information associated with one or more devices of the one or more neighboring wireless user devices in proximity to the paired device at expiration of the update timer that is common to the ID information associated with the one or more neighboring wireless user devices in proximity to the paired device at transmission of the predetermined transmission; and
resending the common ID information within the updated predetermined transmission.

15. The method of claim 13, wherein one or more of the predetermined transmission and the updated predetermined transmission are transmitted using a priority emergency transmission protocol.

16. The method of claim 9, further including:
periodically exchanging one or more confirmation signals between the enhanced ring and the paired device while wirelessly paired;
detecting, by the paired device, a failure of the one or more confirmation signals from the enhanced ring; and
transmitting, via the long-range RAT, the predetermined transmission from the paired device to the one or more designated recipients in response to the failure.

17. The method of claim 16, wherein the failure includes one of:
failure of a single confirmation signal of the one or more confirmation signals from the enhanced ring; or
failure of a predetermined number of confirmation signals of the one or more confirmation signals from the enhanced ring.

18.-39. (canceled)

40. A method of switch-enabled communication performed by an enhanced ring, the method comprising:
establishing wireless pairing with a paired device via a short-range communication radio of the enhanced ring;
periodically exchanging, by the enhanced ring, one or more confirmation signals with the paired device while wirelessly paired;
detecting, by the enhanced ring, physical switch input of a physical switch interface of the enhanced ring, wherein the physical switch input is indicative of activation of the switch-enabled communication; and
transmitting, by the enhanced ring via the short-range communication radio, an activation signal associated with the physical switch input to the paired device in response to the physical switch input.

41. The method of claim 40, wherein the detecting the physical switch input includes one of:
detecting movement of the physical switch interface between one of two switch points; or
detecting movement of the physical switch interface between one of a plurality of switch points; or
detecting a sequence of movement of the physical switch interface between one of: the two switch points or the plurality of switch points.

42. The method of claim 41, wherein the activation signal includes one of:
a single activation signal triggered in response to the detecting the movement of the physical switch interface between the one of two switch points, wherein the single activation signal flags activation of the switch-enabled communication to the paired device; or
a selected activation signal from a plurality of predetermined candidate activation signals selected in response to the detecting one of: the movement of the physical switch interface between the one of the plurality of switch points, or the sequence of movement of the physical switch interface between the one of: the two switch points or the plurality of switch points, wherein each candidate activation signal of the plurality of predetermined candidate activation signals is one of: a distinct predetermined action, or distinct predetermined information.

43.-45. (canceled)
